(19) United States
(12) Patent Application Publication
(10) Pub. No.: US 2026/0150828 A1
(43) Pub. Date: Jun. 4, 2026

(54) FISHING ROD HOLDER FOR BOAT

(71) Applicant: SHENZHEN PLUS INNOVATIONS ELECTRONICS CO., LTD., Shenzhen (CN)

(72) Inventor: ZEBIN XU, Jieyang (CN)

(21) Appl. No.: 18/982,127

(22) Filed: Dec. 16, 2024

(30) Foreign Application Priority Data
Dec. 4, 2024 (CN) 202423005652.2

(51) Int. Cl. A01K 97/10; B63B 17/00

(52) U.S. Cl. CPC A01K 97/10; B63B 17/00

(57) ABSTRACT

A fishing rod holder for a boat includes a support base and a fishing rod holder. One end of the support base in a longitudinal direction is provided with a first installation position, and one end of the support base in a transverse direction is provided with a second installation position. The first installation position and the second installation position are different positions. The fishing rod holder is detachably installed on the first installation position and the second installation position. The support base is capable of being installed on a support platform. By providing two installation positions on the support base, a height of the fishing rod holder can be adjusted, and the support base can also be detachably installed on the support platform. The support platform can be a circular tube, a square tube, a flat surface, and some irregular objects.

### CROSS-REFERENCE TO RELATED APPLICATIONS

The application claims priority of Chinese patent application 2024230056522, filed on Dec. 4, 2024, which is incorporated herein by reference in its entireties.

### TECHNICAL FIELD

The present invention relates to a fishing rod holder for a boat, which is applied in the technical field of fishing auxiliary devices.

### BACKGROUND ART

People love fishing sports, and their fishing methods are the same as their attitude towards life. Sea fishing, as the main fishing method for fishing enthusiasts around the world, is very popular due to its comfort, excitement, and wide fishing range.

In sea fishing, kayaks or boats are often used, and the fishing rod is a professional one. Different kayaks or boats have different structural characteristics, and the peripheral structure of kayaks or boats has circular tubes, square tubes, flat surfaces, and fences of some irregular objects. The existing fishing rod holders on the market are generally welded with a plurality of inclined fishing rod sleeves on the fences on both sides of the boat's rail, and then the fishing rods are inserted into the sleeves. Due to the influence of ocean currents, anchored fishing boats will rotate with the direction of seawater flow, which also brings about the problem of fixedly connected fishing rod sleeves being unable to align with the fishing direction due to limited angles. In addition, the existing fishing rod holders for boats on the market are not suitable for peripheral structures and shapes of different boats, and users cannot choose the fishing position and installation height, which brings inconvenience to the users.

### SUMMARY

In order to solve the problems that fixedly connected fishing rod sleeves in the prior art are unable to align with a fishing direction due to a limited angle, and a user cannot choose a fishing position and an installation height, a fishing rod holder for a boat is provided in the present invention. In the present invention, a support base is provided with two installation positions, which allows the user to adjust a height of the fishing rod holder. The support base is also detachably installed on a support platform, allowing the user to move a position of the fishing rod holder for the boat and adjust an angle of a fishing rod by adjusting the position of the fishing rod holder for the boat, bringing convenience to the user during use. The technical solution adopted by the present invention to solve its technical problems is as follows. A fishing rod holder for a boat is provided in the present invention. The fishing rod holder for the boat includes a support base and a fishing rod holder. One end of the support base in a longitudinal direction is provided with a first installation position, and one end of the support base in a transverse direction is provided with a second installation position. The first installation position and the second installation position are different positions. The fishing rod holder is detachably installed on the first installation position and the second installation position. The support base is capable of being installed on a support platform.

Furthermore, the fishing rod holder is arranged in a transverse direction when installed in the first installation position, and the fishing rod holder is arranged in a longitudinal direction when installed in the second installation position.

Furthermore, the fishing rod holder for the boat further includes a first fixing member. A first installation hole is defined in a bottom portion of the fishing rod holder. The first installation position and the second installation position are each provided with a second installation hole. The first fixing member passes through the first installation hole to be detachably fixed in the second installation hole, so that the fishing rod holder is detachably installed on the support base.

Furthermore, the first fixing member includes a first screw rod and a first handle. The first handle is arranged at one end of the first screw rod. The first screw rod is capable of being installed in the first installation hole and the second installation hole by controlling the first handle.

Furthermore, the fishing rod holder includes a rod holder main body and a connecting member. The first installation hole is defined in the connecting member. The rod holder main body is movably installed on the connecting member. When the rod holder main body is installed on the connecting member, a front end of the rod holder main body is capable of forming an included angle greater than 0 degrees relative to the connecting member. The connecting member is detachably installed on the support base through the first fixing member.

Furthermore, the rod holder main body is provided with a fishing rod installation groove for receiving a fishing rod, so that the fishing rod is capable of being stably installed in the fishing rod installation groove.

Furthermore, the rod holder main body is in a semi-cylinder shape. A hollow position of the semi-cylinder is the fishing rod installation groove. A front end of the semi-cylinder is provided with a second fixing member, and a rear end of the semi-cylinder is provided with a third fixing member. The second fixing member and the third fixing member are combined to fix the fishing rod.

Furthermore, the fishing rod installation groove is internally provided with soft rubber clamping blocks near a rear end of the rod holder main body and near two side edges of the fishing rod installation groove, so that the fishing rod is capable of passing between the two soft rubber clamping blocks.

Furthermore, two ends of the second fixing member are connected to two ends of a side wall of the semi-cylinder, and are fixedly arranged in an arch shape.

Furthermore, one end of the third fixing member is movable and detachable on the side wall of the semi-cylinder.

Furthermore, the fishing rod holder for the boat further includes a fourth fixing member. The rod holder main body and the connecting member are respectively provided with a third installation hole and a fourth installation hole. The fourth fixing member passes through the third installation hole and the fourth installation hole to fix the rod holder main body to the connecting member. The fourth fixing member is detachably inserted into the third installation hole and the fourth installation hole.

Furthermore, the fourth fixing member includes a second screw rod and a second handle. The second handle is arranged at one end of the second screw rod. The second screw rod is capable of being installed in the third installation hole and the fourth installation hole by controlling the second handle.

Furthermore, the connecting member further includes a support ring and a support plate. The support ring is vertically arranged on the support plate, and the first installation hole is defined in the support plate. The fourth installation hole is defined in the support ring.

Furthermore, the support base includes a support base main body and a fifth fixing member. The fifth fixing member is moveably connected to the support base main body. One end of the fifth fixing member forms a clamping space with a side wall of the support base main body. When the fifth fixing member moves, a size of the clamping space is adjustable.

Furthermore, the support base main body includes a first side arm, a second side arm, and one transverse arm. Both ends of the transverse arm are respectively connected to one end of the first side arm and one end of the second side arm, so that the support base main body is U-shaped. A fifth installation hole is defined in the first side arm. The fifth fixing member is movably inserted into the fifth installation hole. The clamping space is formed between one end of the fifth fixing member and the second side arm. The fishing rod holder is detachably installed on the transverse arm.

Furthermore, the fifth fixing member includes a third screw rod, a third handle, and a first V-shaped plate. The third handle and the first V-shaped plate are respectively arranged at both ends of the third screw rod. The support base main body is provided with a second V-shaped plate opposite to the first V-shaped plate. The clamping space is formed between the first V-shaped plate and the second V-shaped plate. The third handle controls movement of the third screw rod and the first V-shaped plate relative to the second V-shaped plate.

Furthermore, when the first V-shaped plate abuts against the second V-shaped plate, the clamping space is capable of being diamond shaped.

Furthermore, a side surface of the first V-shaped plate opposite to the second V-shaped plate and a side surface of the second V-shaped plate opposite to the first V-shaped plate are both provided with anti-slip patterns.

Beneficial effects of the present invention are as follows. The fishing rod holder for the boat is provided in the present invention. Two installation positions are provided on the support base for the user to adjust the height of the fishing rod holder. The support base is also detachably installed on the support platform, allowing the user to move the position of the fishing rod holder for the boat and adjust the angle of the fishing rod by adjusting the position of the fishing rod holder for the boat, bringing convenience to the user during use.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a perspective view of a fishing rod holder for a boat according to the present invention.

FIG. 2 is an exploded view of a fishing rod holder for a boat according to the present invention.

FIG. 3 is a state diagram of angle adjustment between a rod holder main body and a connecting member of a fishing rod holder for a boat according to the present invention.

FIG. 4 is a usage state diagram of a fishing rod holder for a boat according to the present invention.

FIG. 5 is a schematic diagram of installing a fishing rod holder for a boat in a longitudinal direction according to the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

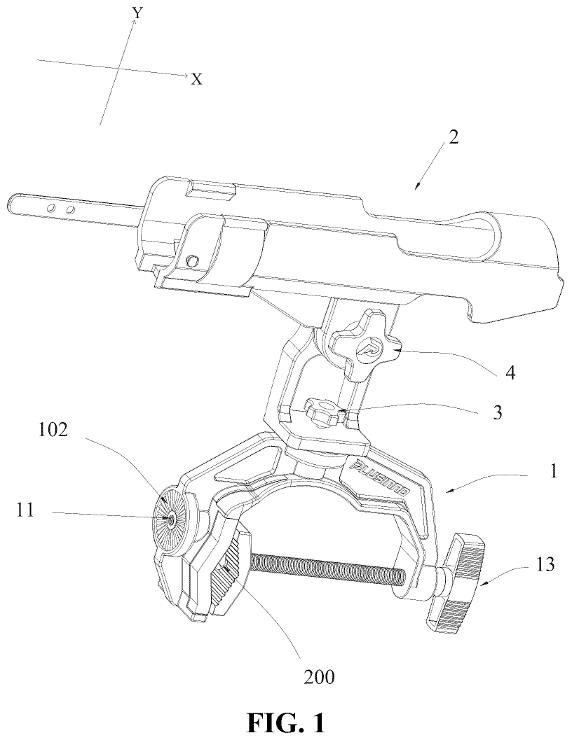

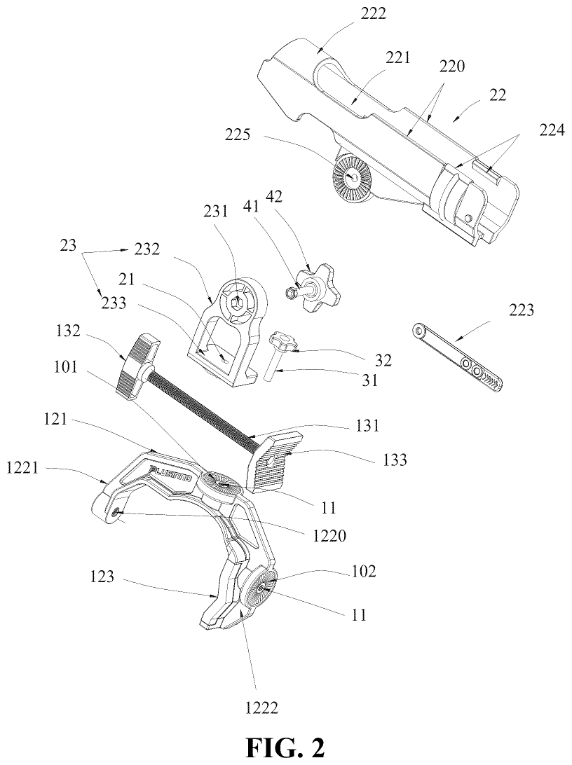

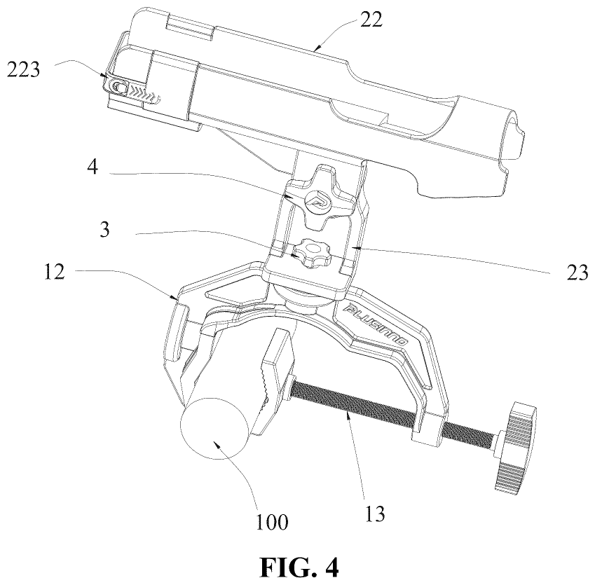

Referring to FIGS. 1-5, a fishing rod holder for a boat is provided in the present invention. The fishing rod holder for the boat includes a support base 1 and a fishing rod holder 2. One end of the support base 1 in a longitudinal direction is provided with a first installation position 101, and one end of the support base 1 in a transverse direction is provided with a second installation position 102. The first installation position 101 and the second installation position 102 are different positions. The fishing rod holder 2 is detachably installed on the first installation position 101 and the second installation position 102. The support base 1 is capable of being installed on a support platform 100. The support platform 100 can be a rod on a guardrail as shown in FIG. 4, a table board, or any support on the boat that can support the fishing rod holder for the boat, making it convenient for a user to move the fishing rod holder for the boat, and making it easy for the user to use. That is to say, by providing two installation positions on the support base, the user can adjust a height of the fishing rod holder. Moreover, the support base is detachably installed on the support platform, allowing the user to move a position of the fishing rod holder for the boat and adjust an angle of a fishing rod by adjusting the position of the fishing rod holder for the boat, thereby bringing convenience to the user during use. The first installation position 101 and the second installation position 102 are used for the installation of the fishing rod holder 2. Therefore, when the fishing rod holder 2 is installed in the first installation position 101 and the second installation position 102, the fishing rod holder 2 can be detachably installed by screws, clamp structures, or buckle structures, making it easy for the user to adjust the fishing rod holder.

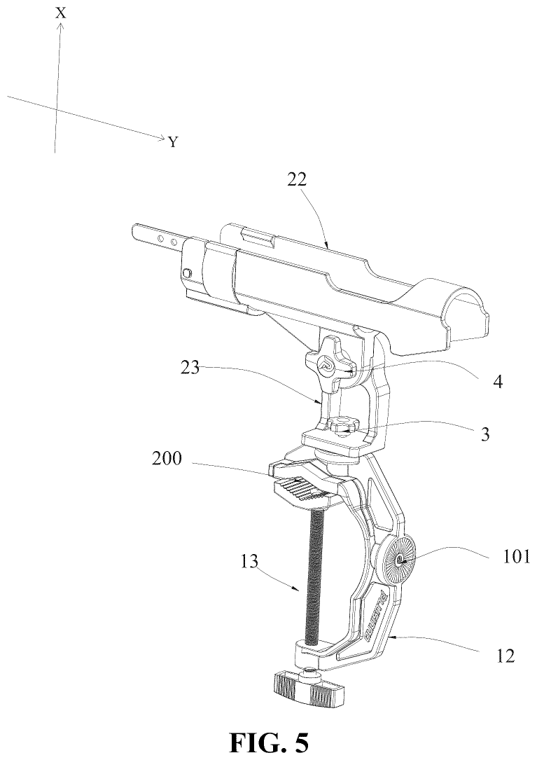

In this embodiment, based on the previous structure, it is further preferred that the fishing rod holder 2 is arranged in a transverse direction when installed in the first installation position 101, and the fishing rod holder 2 is arranged in a longitudinal direction when installed in the second installation position 102. As shown in FIG. 1, the fishing rod holder 2 is arranged in the transverse direction, and as shown in FIG. 4, the fishing rod holder 2 is arranged in the longitudinal direction. A height of the fishing rod holder 2 in the longitudinal direction is higher relative to a height of the fishing rod holder 2 in the transverse direction, so that it is easier for the user to find a position to adjust an angle and a height of the fishing rod. As shown in an X-axis and a Y-axis of FIG. 1 and FIG. 5, the X-axis indicates the transverse direction and the Y-axis indicates the longitudinal direction.

In this embodiment, the fishing rod holder for the boat further includes a first fixing member 3. A first installation hole 21 is defined in a bottom portion of the fishing rod holder 2. The first installation position 101 and the second installation position 102 are each provided with a second installation hole 11. The first fixing member 3 passes through the first installation hole 21 to be detachably fixed in the second installation hole 11, so that the fishing rod holder 2 is detachably installed on the support base 1, facilitating the user to adjust an angle of the fishing rod holder relative to the support base and adjust an angle of the fishing rod holder, and making it more convenient for the user to control a fishing angle of the fishing rod.

In this embodiment, the first fixing member 3 includes a first screw rod 31 and a first handle 32. The first handle 32 is arranged at one end of the first screw rod 31. The first screw rod 31 is capable of being installed in the first installation hole 21 and the second installation hole 11 by controlling the first handle 32, and the fishing rod holder is capable of being installed on the support base 1 by the first fixing member 3 without the use of external tools, such as a screwdriver and other tools, that is, it is easy for the user to install the fishing rod holder 2 on the support base 1. If the first fixing member 3 is a cross bolt or a regular bolt without a cross, external tools are required. Without tools, it is difficult for the user to disassemble the first fixing member. Therefore, the arrangement of the first handle 32 greatly facilitates the use by the user.

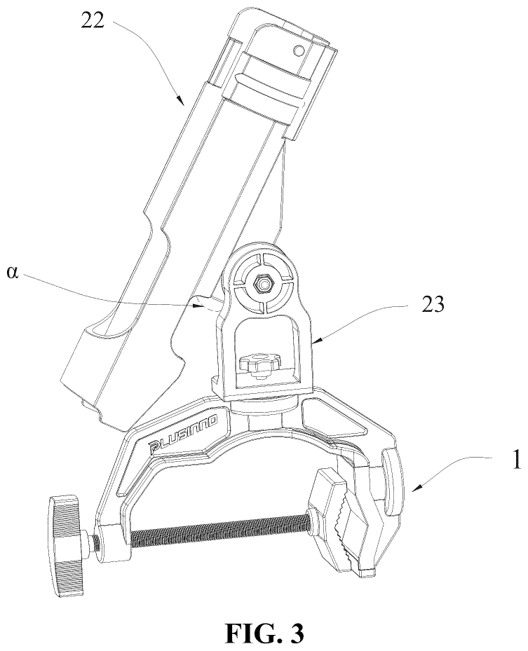

In this embodiment, the fishing rod holder 2 includes a rod holder main body 22 and a connecting member 23. The first installation hole 21 is defined in the connecting member 23. The rod holder main body 22 is movably installed on the connecting member 23. The connecting member 23 is detachably installed on the support base 1 through the first fixing member 3. When the rod holder main body 22 is installed on the connecting member 23, a front end of the rod holder main body 22 is capable of forming an included angle α greater than 0 degrees relative to the connecting member 23, as shown in FIG. 3. That is to say, the user can adjust the front end of the rod holder main body 22 to be close to the connecting member 23, or adjust the front end of the rod holder main body 22 to be away from the connecting member 23. This arrangement allows an angle of the rod holder main body 22 to be adjusted, that is, the fishing angle of the fishing rod can be adjusted, allowing the user to adjust the angle of the fishing rod from a plurality of angles, improving the practicality of using the fishing rod holder for the boat.

In this embodiment, the rod holder main body 22 is provided with a fishing rod installation groove 221 for receiving a fishing rod, so that the fishing rod is capable of being stably installed in the fishing rod installation groove 221, and the installation groove is convenient for placement of the fishing rod.

In this embodiment, the rod holder main body 22 is in a semi-cylinder shape. A hollow position of the semi-cylinder is the fishing rod installation groove 221. A front end of the semi-cylinder is provided with a second fixing member 222, and a rear end of the semi-cylinder is provided with a third fixing member 223. The second fixing member 222 and the third fixing member 223 are combined to fix the fishing rod. The simple design fixes the fishing rod into the installation groove. Compared with directly arranging the rod holder main body 22 in a cylindrical shape, the above structure is more designed and reduces a weight of the fishing rod holder for the boat, increasing the user's favorability.

In this embodiment, the fishing rod installation groove 221 is internally provided with soft rubber clamping blocks 224 near a rear end of the rod holder main body 22 and near two side edges 220 of the fishing rod installation groove 221, so that the fishing rod is capable of passing between the two soft rubber clamping blocks 224, which can ensure stable installation of the fishing rod and adapt to different sizes of fishing rods.

In this embodiment, two ends of the second fixing member 222 are connected to two ends of a side wall of the semi-cylinder, and are fixedly arranged in an arch shape to adapt to a cylinder shape of the fishing rod, which is convenient for the user to use. The second fixing member is integrally formed with the semi-cylinder.

In this embodiment, one end of the third fixing member 223 is movable and detachable on the side wall of the semi-cylinder. That is to say, when the fishing rod is installed in the installation groove, whether the third fixing member 22 needs to be used may be determined according to a size of the fishing rod. If the fishing rod is not very stable when placed in the installation groove, the third fixing member 223 needs to be used to fix the fishing rod stably. The third fixing member 223 can be a rope, an elastic band or a tape. In this embodiment, it is preferred that the third fixing member is an elastic band. The elastic band has greater frictional force, and the elasticity of the elastic band can adapt to various sizes of fishing rods.

In this embodiment, the fishing rod holder for the boat further includes a fourth fixing member 4. The rod holder main body 22 and the connecting member 23 are respectively provided with a third installation hole 225 and a fourth installation hole 231. The fourth fixing member 4 passes through the third installation hole 225 and the fourth installation hole 231 to fix the rod holder main body 22 to the connecting member 23. The fourth fixing member 4 is detachably inserted into the third installation hole 225 and the fourth installation hole 231, so that an angle of the rod holder main body 22 can be adjusted, which is convenient for the user to adjust the fishing rod from a plurality of angles.

In this embodiment, the fourth fixing member 4 includes a second screw rod 41 and a second handle 42. The second handle 42 is arranged at one end of the second screw rod 41. The second screw rod 41 is capable of being installed in the third installation hole 225 and the fourth installation hole 231 by controlling the second handle 42, and the rod holder main body 22 is capable of being installed on the connecting member 23 through the fourth fixing member 4 without the use of external tools, such as a screwdriver and other tools. That is, it is convenient for the user to install the rod holder main body 22 on the connecting member 23. If the fourth fixing member 4 is a cross bolt or a regular bolt without a cross, external tools are required. Without tools, it is difficult for the user to disassemble the first fixing member. Therefore, the arrangement of the second handle 42 greatly facilitates the use by the user.

In this embodiment, the connecting member 23 further includes a support ring 232 and a support plate 233. The support ring 232 is vertically arranged on the support plate 233, and the first installation hole 21 is defined in the support plate 233. The fourth installation hole 231 is defined in the support ring 232. The support ring 232 and the support plate 233 are integrally formed. This arrangement makes the installation of the third fixing member 223 and the fourth fixing member 4 more stable, makes the fishing rod holder for the boat more designed, and also reducing the weight of the fishing rod holder for the boat.

In this embodiment, the support base 1 includes a support base main body 12 and a fifth fixing member 13. The fifth fixing member 13 is movably connected to the support base main body 12. One end of the fifth fixing member 13 forms a clamping space 200 with a side wall of the support base main body 12. When the fifth fixing member 13 moves, a size of the clamping space 200 is adjustable. This structure is convenient for the user to install the fishing rod holder for the boat at any position on the boat, and is also convenient for the user to disassemble.

In this embodiment, the support base main body 12 includes a first side arm 1221, a second side arm 1222, and one transverse arm 121. Both ends of the transverse arm 121 are respectively connected to one end of the first side arm 1221 and one end of the second side arm 1222, so that the support base main body 12 is U-shaped. A fifth installation hole 1220 is defined in the first side arm 1221. The fifth fixing member 13 is movably inserted into the fifth installation hole 1220. The clamping space 200 is formed between one end of the fifth fixing member 13 and the second side arm 1222. The fishing rod holder 2 is detachably installed on the transverse arm 121. The arrangement of the above structure is simple, making it easy for the user to stably install the fishing rod holder for the boat at any position on the boat.

In this embodiment, the fifth fixing member 13 includes a third screw rod 131, a third handle 132, and a first V-shaped plate 133. The third handle 132 and the first V-shaped plate 133 are respectively arranged at both ends of the third screw rod 131. The support base main body 12 is provided with a second V-shaped plate 123 opposite to the first V-shaped plate 133. The clamping space 200 is formed between the first V-shaped plate 133 and the second V-shaped plate 123. The third handle 132 controls movement of the third screw rod 131 and the first V-shaped plate 133 relative to the second V-shaped plate 123. The arrangement of the first V-shaped plate 133 and the second V-shaped plate 123 enables the fishing rod holder for the boat to be more stable when clamped at any position on the boat. If both the first V-shaped plate 133 and the second V-shaped plate 123 are not arranged in a V-shape but are arranged as flat plates, when the fishing rod is positioned between the two flat plates, the fishing rod is prone to slip under gravity if a force between the two flat plates is not sufficient, but the fishing rod is prone to wear and tear if the force is too large. Therefore, arranging the first V-shaped plate 133 and the second V-shaped plate 123 can protect the fishing rod, and reduce the wear on the fishing rod. Moreover, opposite side surfaces of the first V-shaped plate 133 and the second V-shaped plate 123 are both equipped with anti-slip patterns to prevent the fishing rod from slipping in a direction of gravity due to the influence of gravity.

In this embodiment, when the first V-shaped plate 133 abuts against the second V-shaped plate 123, the clamping space 200 is capable of being diamond shaped, that is, a size of the first V-shaped plate 133 and a size of the second V-shaped plate 123 can be relatively consistent, and the force can be balanced.

In summary, the fishing rod holder for the boat in this embodiment can not only be conveniently and stably installed on the support platform 100 through the fifth fixing member 13, but also adjust the angle between the fishing rod holder 2 and the support base 1 through the first fixing member 3, and adjust the angle between the rod holder main body 22 and the connecting member 23 through the fourth fixing member 4. The fishing rod holder 2 can also be arranged in the longitudinal direction or the transverse direction of the support base 1, allowing the user to adjust the angle of supporting the fishing rod in a plurality of directions, increasing the practicality of the fishing rod holder for the boat in this embodiment and improving the user experience.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A fishing rod holder for a boat, comprising:
a support base; and
a fishing rod holder;
wherein one end of the support base in a longitudinal direction is provided with a first installation position, and one end of the support base in a transverse direction is provided with a second installation position; the first installation position and the second installation position are different positions; the fishing rod holder is detachably installed on the first installation position and the second installation position; and the support base is capable of being installed on a support platform.

2. The fishing rod holder for the boat according to claim 1, wherein the fishing rod holder is arranged in a transverse direction when installed in the first installation position, and the fishing rod holder is arranged in a longitudinal direction when installed in the second installation position.

3. The fishing rod holder for the boat according to claim 1, further comprising a first fixing member, wherein a first installation hole is defined in a bottom portion of the fishing rod holder;
the first installation position and the second installation position are each provided with a second installation hole; and the first fixing member passes through the first installation hole to be detachably fixed in the second installation hole, so that the fishing rod holder is detachably installed on the support base.

4. The fishing rod holder for the boat according to claim 3, wherein the first fixing member comprises a first screw rod and a first handle; the first handle is arranged at one end of the first screw rod; and the first screw rod is capable of being installed in the first installation hole and the second installation hole by controlling the first handle.

5. The fishing rod holder for the boat according to claim 3, wherein the fishing rod holder comprises a rod holder main body and a connecting member; the first installation hole is defined in the connecting member; the rod holder main body is movably installed on the connecting member; when the rod holder main body is installed on the connecting member, a front end of the rod holder main body is capable of forming an included angle greater than 0 degrees relative to the connecting member; and the connecting member is detachably installed on the support base through the first fixing member.

6. The fishing rod holder for the boat according to claim 5, wherein the rod holder main body is provided with a fishing rod installation groove for receiving a fishing rod, so that the fishing rod is capable of being stably installed in the fishing rod installation groove.

7. The fishing rod holder for the boat according to claim 6, wherein the rod holder main body is in a semi-cylinder shape; a hollow position of the semi-cylinder is the fishing rod installation groove; a front end of the semi-cylinder is provided with a second fixing member; a rear end of the semi-cylinder is provided with a third fixing member; and the second fixing member and the third fixing member are combined to fix the fishing rod.

8. The fishing rod holder for the boat according to claim 7, wherein the fishing rod installation groove is internally provided with soft rubber clamping blocks near a rear end of the rod holder main body and near two side edges of the fishing rod installation groove, so that the fishing rod is capable of passing between the two soft rubber clamping blocks.

9. The fishing rod holder for the boat according to claim 7, wherein two ends of the second fixing member are connected to two ends of a side wall of the semi-cylinder, and are fixedly arranged in an arch shape.

10. The fishing rod holder for the boat according to claim 7, wherein one end of the third fixing member is movable and detachable on the side wall of the semi-cylinder.

11. The fishing rod holder for the boat according to claim 5, further comprising a fourth fixing member, wherein the rod holder main body and the connecting member are respectively provided with a third installation hole and a fourth installation hole; the fourth fixing member passes through the third installation hole and the fourth installation hole to fix the rod holder main body to the connecting member; and the fourth fixing member is detachably inserted into the third installation hole and the fourth installation hole.

12. The fishing rod holder for the boat according to claim 11, wherein the fourth fixing member comprises a second screw rod and a second handle; the second handle is arranged at one end of the second screw rod; and the second screw rod is capable of being installed in the third installation hole and the fourth installation hole by controlling the second handle.

13. The fishing rod holder for the boat according to claim 11, wherein the connecting member further comprises a support ring and a support plate; the support ring is vertically arranged on the support plate; the first installation hole is defined in the support plate; and the fourth installation hole is defined in the support ring.

14. The fishing rod holder for the boat according to claim 1, wherein the support base comprises a support base main body and a fifth fixing member; the fifth fixing member is moveably connected to the support base main body; one end of the fifth fixing member forms a clamping space with a side wall of the support base main body; and when the fifth fixing member moves, a size of the clamping space is adjustable.

15. The fishing rod holder for the boat according to claim 14, wherein the support base main body comprises a first side arm, a second side arm, and one transverse arm; both ends of the transverse arm are respectively connected to one end of the first side arm and one end of the second side arm, so that the support base main body is U-shaped; a fifth installation hole is defined in the first side arm; the fifth fixing member is movably inserted into the fifth installation hole; the clamping space is formed between one end of the fifth fixing member and the second side arm; and the fishing rod holder is detachably installed on the transverse arm.

16. The fishing rod holder for the boat according to claim 13, wherein the fifth fixing member comprises a third screw rod, a third handle, and a first V-shaped plate; the third handle and the first V-shaped plate are respectively arranged at both ends of the third screw rod; the support base main body is provided with a second V-shaped plate opposite to the first V-shaped plate; the clamping space is formed between the first V-shaped plate and the second V-shaped plate; and the third handle controls movement of the third screw rod and the first V-shaped plate relative to the second V-shaped plate.

17. The fishing rod holder for the boat according to claim 16, wherein when the first V-shaped plate abuts against the second V-shaped plate, the clamping space is capable of being diamond shaped.

18. The fishing rod holder for the boat according to claim 16, wherein a side surface of the first V-shaped plate opposite to the second V-shaped plate and a side surface of the second V-shaped plate opposite to the first V-shaped plate are both provided with anti-slip patterns.
